(19) United States
(12) Patent Application Publication
(10) Pub. No.: US 2020/0401810 A1
(43) Pub. Date: Dec. 24, 2020

(54) COMPUTER DEVICE AND METHOD FOR MONITORING AN OBJECT

(71) Applicant: TRIPLE WIN TECHNOLOGY(SHENZHEN) CO.LTD., Shenzhen (CN)

(72) Inventor: KUO-HUNG LIN, New Taipei (TW)

(21) Appl. No.: 16/553,646

(22) Filed: Aug. 28, 2019

(30) Foreign Application Priority Data
Jun. 21, 2019 (CN) 201910545143.3

(51) Int. Cl. G06K 9/00; G01C 21/36

(52) U.S. Cl. CPC G06K 9/00744; G06K 9/00825; G06K 2209/23; G01C 21/3647; G06K 2209/15; G06K 9/00798

(57) ABSTRACT

A method for monitoring an object is provided. The method includes acquiring videos recorded by an imaging device of a vehicle and position of the vehicle, and storing the videos and the position into a database, and receiving a monitoring command from a terminal device, wherein the monitoring command comprising a dynamic monitoring command and/or a static monitoring command. The method further can obtain a search result by searching in the database according to the monitoring command and/or the static monitoring command and output the search result.

### CROSS-REFERENCE TO RELATED APPLICATIONS

This application claims priority to Chinese Patent Application No. 201910545143.3 filed on Jun. 21, 2019, the contents of which are incorporated by reference herein.

### FIELD

The subject matter herein generally relates to monitoring technology field.

### BACKGROUND

A driving recorder has become part of a basic configuration of a vehicle. The driving recorder can record the driving state of the vehicle on the current road when the vehicle is being driven, and the state of the surroundings and pedestrians on both sides of the road also can be recorded.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 shows a schematic diagram of one embodiment of a method for monitoring an object of the present disclosure.

FIG. 2 is a flowchart of an embodiment of a method for monitoring an object of the present disclosure.

FIG. 3 shows one embodiment of modules of a monitoring device of the present disclosure.

FIG. 4 shows one embodiment of a schematic structural diagram of a computer device of the present disclosure.

### DETAILED DESCRIPTION

In order to provide a more clear understanding of the objects, features, and advantages of the present disclosure, the same are given with reference to the drawings and specific embodiments. It should be noted that the embodiments in the present disclosure and the features in the embodiments may be combined with each other without conflict.

In the following description, numerous specific details are set forth in order to provide a full understanding of the present disclosure. The present disclosure may be practiced otherwise than as described herein. The following specific embodiments are not to limit the scope of the present disclosure.

Unless defined otherwise, all technical and scientific terms herein have the same meaning as used in the field of the art technology as generally understood. The terms used in the present disclosure are for the purposes of describing particular embodiments and are not intended to limit the present disclosure.

The present disclosure, referencing the accompanying drawings, is illustrated by way of examples and not by way of limitation. It should be noted that references to “an” or “one” embodiment in this disclosure are not necessarily to the same embodiment, and such references mean “at least one.”

Furthermore, the term “module”, as used herein, refers to logic embodied in hardware or firmware, or to a collection of software instructions, written in a programming language, such as Java, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media include CDs, DVDs, BLU-RAY, flash memory, and hard disk drives.

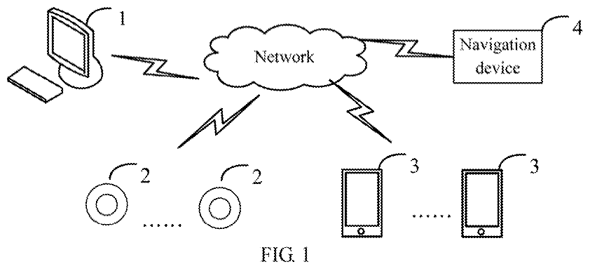

FIG. 1 shows a schematic diagram of one embodiment of a method for monitoring an object of the present disclosure. The monitoring method is applied to a computer device 1. The computer device 1, at least one imaging device 2, at least one terminal device 3, and a navigation device 4 communicated with each other through a network. The network can be a wired network or a wireless network, such as radio, Wireless Fidelity (WIFI), cellular, satellite, broadcast, and the like.

In at least one embodiment, the computer device 1 may be an electronic device installed with monitoring method software, such as a personal computer, a server, or the like. The server may be a single server, a server cluster, a cloud server, or the like.

In at least one embodiment, the imaging device 2 is an electronic device having a video capturing function. The imaging device 2 can include, but is not limited to, a driving recorder, a camera, and the like. The imaging device 2 is disposed on a vehicle. The imaging device 2 can capture a video of surroundings of the moving vehicle.

In at least one embodiment, the terminal device 3 is an intelligent electronic device having a display screen. The terminal device 3 can be a smart phone, a tablet computer, a laptop convenient computer, a desktop computer, and so on.

In at least one embodiment, the navigation device 4 is an electronic device having a function of navigation and positioning. The navigation device 4 can be a car navigation system, or a driving recorder with navigation functions, or a smart phone, and the like. The navigation device 4 can establish the geographical position of the vehicle while the vehicle is in motion.

In at least one embodiment, the at least one imaging device 2 can be disposed on the vehicle. The imaging device 2 is a driving recorder. The driving recorder can transmit the acquired video information and current position of the vehicle to the computer device 1 through a network. The network can be 5G. The network can also be a wired network or wireless network. The computer device 1 can extract features from the acquired video and compress the acquired video. The terminal device 3 can send a monitoring request to the computer device 1 for querying a track of a vehicle. The computer device 1 can obtain a search result according to the monitoring request, and send the search result to the terminal device 3.

In other embodiments, in addition to the imaging device 2, the vehicle further includes the navigation device 4. The navigation device 4 can obtain the current position of the vehicle and transmit the current position to the computer device 1. When the imaging device 2 on the vehicle can record the video and send the video to the computer device 1, the navigation device 4 can send the current position of the vehicle to the computer device 1 simultaneously. For example, when a user needs to query a status of a billboard outside a building through the terminal device 3, the terminal device 3 can send a monitoring request to the computer device 1. The computer device 1 can search for vehicles which are recording around the building according to the location of the building, and acquire videos from the searched vehicles. The computer device 1 further can obtain the status of the billboard from the acquired videos through an image recognition technology, and send the status of the billboard to the terminal device 3.

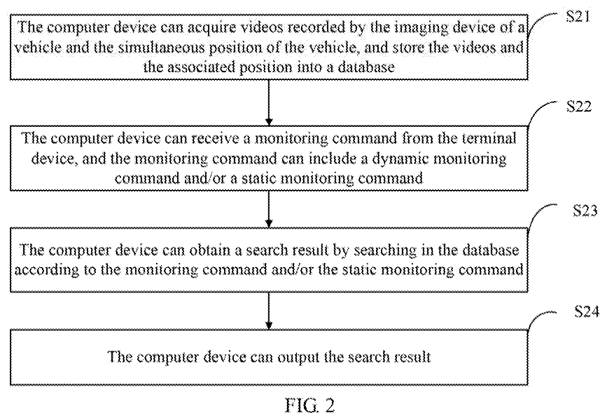

FIG. 2 illustrates a flowchart of a monitoring method of the computer device 1. In an example embodiment, the method is performed by execution of computer-readable software program codes or instructions by the computer device 1.

Referring to FIG. 2, the method is provided by way of example, as there are a variety of ways to carry out the method. The method described below can be carried out using the configurations illustrated in FIG. 1, for example, and various elements of these figures are referenced in explaining method. Each block shown in FIG. 2 represents one or more processes, methods, or subroutines, carried out in the method. Furthermore, the illustrated order of blocks is illustrative only and the order of the blocks can be changed. Additional blocks can be added or fewer blocks can be utilized without departing from this disclosure. The example method can begin at block S21.

At block S21, the computer device 1 can acquire videos recorded by the imaging device of a vehicle and the simultaneous position of the vehicle, and store the videos and the associated position into a database.

In at least one embodiment, the step for acquiring videos recorded by the imaging device 2 of a vehicle and position of the vehicle, and storing the videos and the position to a database can include: the computer device 1 can receive the videos send by the imaging device 2 of the vehicle, the computer device 1 can receive the position of the vehicle send by the navigation device 4 of the vehicle at the same time. The computer device 1 can extract feature information from the videos, and the feature information can be license plate number of at least one vehicle of the videos, the computer device 1 can compress the videos by an image compression technology, and the computer device 1 can store the compressed videos, the extracted feature information, and the position of the vehicle into the database according to a preset rule. For example, the computer device 1 can receive the videos send by the imaging device 2 of the vehicle at 8:00, and the navigation device 4 of the vehicle can acquire a position A of the vehicle at 8:00. The computer device 1 can receive the videos and the position A at the same time.

In at least one embodiment, the imaging device 2 can include an identification number, and the imaging device 2 can establish a relational table according to at least one video recorded by the imaging device 2 and an identification number of the imaging device 2. The computer device 1 can receive the relational table send by the imaging device 2.

In at least one embodiment, the step for extracting feature information from the videos can include: the computer device 1 can search for at least one key frame containing the feature information from the videos, the computer device 1 can extract the feature information from the at least one key frame by an image recognition technology.

In at least one embodiment, the imaging device 2 of the vehicle can be a driving recorder. The driving recorder can record videos when the vehicle is moving. Information of the video can include roads and other vehicles in front of the vehicle, and buildings on both sides of the roads. The driving recorder can send the videos to the computer device 1. The vehicle further includes the navigation device 4. The navigation device 4 can be a car navigation device, and the navigation device 4 can obtain current position of the vehicle and send the current position of the vehicle to the computer device 1 when the computer device 1 is receiving the videos.

In at least one embodiment, the computer device 1 can extract the at least one key frame from the videos by a programming language. For example, the computer device 1 can invoke a Python program to identify the at least one key frame from the videos. The computer device 1 can extract license plate contained in the at least one key frame by a method of image recognition. For example, the computer device 1 can extract license plate contained in the at least one key frame by the method of image recognition based on a neural network. The computer device 1 also can compress the videos losslessly by an image compression method. For example, the computer device 1 can compress the videos by an MPEG4-based image compression technology, and by a DivX encoding method to compress the videos. The compressed video can occupy less memory space of the computer device 1 and can be sent to the terminal device 3 conveniently. The computer device 1 can store the extracted license plate, the compressed videos, and the position information of the current vehicle in the database.

In other embodiment, the imaging device 2 is mounted on one side of the vehicle. The imaging device 2 is a camera. The camera can record video when the vehicle is driving. Information of the video can include roads and other vehicles in front of the vehicle, and buildings on both sides of the roads. The camera can send the videos to the computer device 1. The vehicle further includes the navigation device 4. The navigation device 4 can be a smart phone having a navigation function, and the smart phone can obtain current position of the vehicle and send the current position of the vehicle to the computer device 1 when the computer device 1 is receiving the videos.

In other embodiment, the computer device 1 can extract the at least one key frame from the videos by a programming language. For example, the computer device 1 can invoke a Java program to identify the at least one key frame from the videos. The computer device 1 can extract license plate contained in the at least one key frame by a method of image recognition. For example, the computer device 1 can extract license plate contained in the at least one key frame by the method of image recognition based on wavelet transform. The computer device 1 also can compress the videos by an image compression method. For example, the computer device 1 can compress the videos by an image compression technology based on H.265, and by an .avi encoding method to compress the videos losslessly. The compressed video can occupy less memory space of the computer device 1 and can be sent to the terminal device 3 conveniently. The computer device 1 can store the extracted license plate, the compressed videos, and the position information of the current vehicle in the database.

At block S22, the computer device 1 can receive a monitoring command from the terminal device 3, and the monitoring command can include a dynamic monitoring command and/or a static monitoring command.

In at least one embodiment, the dynamic monitoring command can include a license plate number of an object vehicle to be monitored and a driving track of the object vehicle. The static monitoring command can include an object to be monitored and monitoring content of the object. For example, the dynamic monitoring command can be a request to inquire current position of the object vehicle with the license plate number 123456, and the driving track of the object vehicle. The static monitoring command can be a request to inquire about contents of a billboard at en entrance of a department store, and check a status of a ticket office at an entrance of a park and so on.

In at least one embodiment, the computer device 1 can determine an authority or status of the terminal device 3. For example, the computer device 1 can determine whether the terminal device 3 corresponding to the monitoring command has an authority to raise queries. When the terminal device 3 does not have the query authority, the computer device 1 can send a query failure notification to the terminal device 3.

At block S23, the computer device 1 can obtain a search result by searching in the database according to the monitoring command and/or the static monitoring command.

In at least one embodiment, the step for searching in the database according to the monitoring command can include: the computer device 1 can search for a license plate number of an object vehicle according to the dynamic monitoring command, the computer device 1 can search for at least one video of the object vehicle having the license plate number, the computer device 1 can acquire positions of the object vehicle of the at least one video and record time information when the object vehicle appeared at the acquired positions. The computer device 1 can acquire a driving track of the object vehicle by connecting the positions on a map according to the recorded time information, and search for an object imaging device which records a newly video shows the object vehicle based on the relational table. The computer device 1 further can acquire a current video from the object imaging device, and determine whether the current video shows the object vehicle. The computer device 1 can output all the videos shows the object vehicle which record by the searched imaging device and the driving track when the current video shows the object vehicle. The computer device 1 can search for the object vehicle from the videos of the database when the current video does not show the object vehicle.

In at least one embodiment, the computer device 1 can acquire a driving track of the object vehicle by connecting the positions on a map according to the recorded time information. For example, the computer device 1 can acquire position A of the object vehicle of the at least one video and recorded time information (e.g., 8:00) when the object vehicle appeared at the position A, the computer device 1 can acquire position B of the object vehicle of the at least one video and recorded time information (e.g., 9:00) when the object vehicle appeared at the position B, and the computer device 1 can acquire position C of the object vehicle of the at least one video and recorded time information (e.g., 10:00) when the object vehicle appeared at the position C. Then, the computer device 1 can acquire a driving track of the object vehicle by connecting the positions A, B, and C, and the driving track may be from A to B, and from B to C.

The computer device 1 can search for the imaging device 2 which records a newly video shows the object vehicle based on the relational table. For example, a first imaging device has record a video A shows the object vehicle at 8:00, and a video B shows the object vehicle at 10:00. A second imaging device has record a video C shows the object vehicle at 11:00, and a video D shows the object vehicle at 14:00. The computer device 1 can receive the video A, the video B, the video C, the video D, and the relational table. The relational table can include a first identification number of the first imaging device, and a second identification number of the second imaging device. The first identification number is corresponding to the video A and the video B. The second identification number is corresponding to the video C and the video D. The computer device 1 further can search for the second imaging device as the video D is the newly video shows the object vehicle.

In at least one embodiment, the step for searching in the database according to the static monitoring command can include: the computer device 1 can acquire position of an object to be monitored according to the static monitoring command, the computer device 1 can search for license plate numbers of vehicles within a preset range of the acquired position. For example, the preset range of the acquired position can be a circle, a center of the circle is the acquired position, and a radius of the circle is 10 meters. The computer device 1 further can acquire videos recorded by imaging device of the vehicles according to the license plate numbers. The computer device 1 can recognize the object to be monitored from the acquired videos by image recognizing technology. The computer device 1 can determine whether the object is normal by comparing a state of the recognized object with a first state of the object stored in the database. For example, when the state of the recognized object is the same as the first state of the object, the computer device 1 can determined that the object is normal. When the state of the recognized object is different from the first state of the object, the computer device 1 can determined that the object is abnormal.

For example, the computer device 1 can receive a monitoring command sent by the terminal device 3 for tracking an object vehicle which has license plate number 123456. The computer device 1 can search for the license plate number from the database, and search for videos and positions of the object vehicle according to the license plate number. The computer device 1 can acquire a driving track by marking the searched positions on the map according to a time sequence of the videos. The computer device 1 can search for an object imaging device which records a newly recorded video shows the object vehicle based on the table, and the computer device 1 further can acquire a current video from the object imaging device, and determine whether the current video has the object vehicle. The computer device 1 can output the video when the the current video has the object vehicle, and can search for the object vehicle in the database when the current video does not show the object vehicle.

In other embodiment, the computer device 1 can receive a monitoring command sent by the terminal device 3 to monitor a display of products in the window of a shopping mall. The computer device 1 can search for the license plate numbers located within 10 meters of the shopping mall according to the location of the shopping mall, and acquires videos having the license plate numbers. The computer device 1 can obtain images showing a merchandise placement of the products in the window. The images are recognized by a deep learning algorithm based on a convolutional neural network. The computer device 1 can determine whether a state of the products is normal by comparing the merchandise placement of the products with a preset placement of the products in the database. When the merchandise placement of the products is the same as the preset placement of the products, the computer device 1 can determine that the state of the products is normal. When the merchandise placement of the products is different from the preset placement of the products, the computer device 1 can determine that the state of the products is abnormal.

At block S4, the computer device 1 can output the result of search.

In at least one embodiment, the search result can be sent to the terminal device 3 by any one of mail, short message, telephone, and instant messaging software.

For example, the computer device 1 can send the search result to the terminal device 3 by mail, short message, telephone, or instant messaging software. The search result can include videos and/or feature information of the videos.

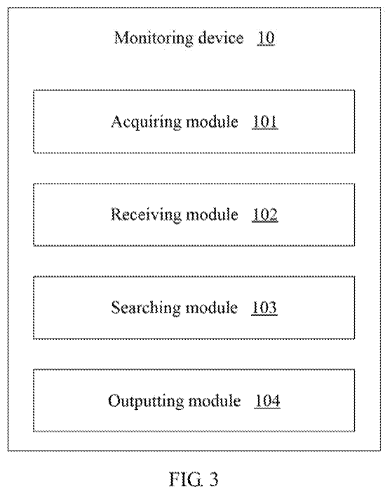

FIG. 3 shows an embodiment of modules of a monitoring device of the present disclosure.

In some embodiments, the monitoring device 10 runs in a computer device 1. The computer device 1 is connected with at least one terminal device 3 by a network. The monitoring device 10 can include a plurality of modules. The plurality of modules can comprise computerized instructions in a form of one or more computer-readable programs that can be stored in a non-transitory computer-readable medium (e.g., a storage device of the computer device), and executed by at least one processor of the computer device to implement monitoring function (described in detail in FIG. 2).

In at least one embodiment, the monitoring device 10 can include a plurality of modules. The plurality of modules can include, but is not limited to an acquiring module 101, a receiving module 102, a searching module 103, and an outputting module 104. The modules 101-104 can comprise computerized instructions in the form of one or more computer-readable programs that can be stored in the non-transitory computer-readable medium (e.g., the storage device of the computer device), and executed by the at least one processor of the computer device to implement the monitoring function (e.g., described in detail in FIG. 1).

The acquiring module 101 can acquire videos recorded by the imaging device 2 of a vehicle and the simultaneous position of the vehicle, and store the videos and the associated position into a database.

In at least one embodiment, the acquiring module 101 can receive the videos send by the imaging device 2 of the vehicle, the acquiring module 101 can receive the position of the vehicle send by the navigation device 4 of the vehicle, the computer device 1 can extract feature information from the videos, and the feature information can be license plate number of at least one vehicle of the videos, the acquiring module 101 can compress the videos by an image compression technology, and the acquiring module 101 can store the compressed videos, the extracted feature information, and the position of the vehicle into the database according to a preset rule.

In at least one embodiment, the imaging device 2 can include an identification number, and the imaging device 2 can establish a relational table according to the imaging device and the identification number. The acquiring module 101 can receive the relational table send by the imaging device.

In at least one embodiment, the acquiring module 101 can search for at least one key frame containing the feature information from the videos, and can extract the feature information from the at least one key frame by an image recognition technology.

In at least one embodiment, the imaging device 2 of the vehicle can be a recorder which is activated when the vehicle is moving. Information of the video can include roads and other vehicles in front of the vehicle, and buildings on both sides of the roads. The driving recorder can send the videos to the computer device 1. The vehicle further includes the navigation device 4. The navigation device 4 can be a car navigation device, and the navigation device 4 can obtain current position of the vehicle and send the current position of the vehicle to the computer device 1 when the computer device 1 is receiving the videos.

In at least one embodiment, the acquiring module 101 can extract the at least one key frame from the videos by a program. For example, the acquiring module 101 can invoke a Python program to identify the at least one key frame from the videos. The acquiring module 101 can extract license plate contained in the at least one key frame by a method of image recognition. For example, the acquiring module 101 can extract license plate contained in the at least one key frame by the method of image recognition based on a neural network. The acquiring module 101 also can compress the videos by an image compression method. For example, the acquiring module 101 can compress the videos by an MPEG4-based image compression technology, and by a DivX encoding method to compress the videos without losing video information. The compressed video can occupy less memory space of the computer device 1 and can be sent to the terminal device 3 conveniently. The acquiring module 101 can store the extracted license plate, the compressed videos, and the position information of the current vehicle in the database.

In other embodiment, the imaging device 2 is mounted on one side of the vehicle. The imaging device 2 is a camera. The camera can record video when the vehicle is moving. Information of the video can include roads and other vehicles in front of the vehicle, and buildings on both sides of the roads. The camera can send the videos to the computer device 1. The vehicle further includes the navigation device 4. The navigation device 4 can be a smart phone having a navigation function, and the smart phone can obtain current position of the vehicle and send the current position of the vehicle to the computer device 1 when the computer device 1 is receiving the videos.

In other embodiment, the acquiring module 101 can extract the at least one key frame from the videos by a program. For example, the acquiring module 101 can invoke a Java program to identify the at least one key frame from the videos. The acquiring module 101 can extract license plate contained in the at least one key frame by a method of image recognition. For example, the computer device 1 can extract license plate contained in the at least one key frame by the method of image recognition based on wavelet transform. The acquiring module 101 also can compress the videos by an image compression method. For example, the acquiring module 101 can compress the videos by an image compression technology based on H.265, and by an .avi encoding method to compress the videos without losing video information. The compressed video can occupy less memory space of the computer device 1 and can be sent to the terminal device 3 conveniently. The acquiring module 101 can store the extracted license plate, the compressed videos, and the position information of the current vehicle in the database.

The receiving module 102 can receive a monitoring command from the terminal device 3 which the monitoring command can include a dynamic monitoring command and/or a static monitoring command.

In at least one embodiment, the dynamic monitoring command can include a license plate number of an object vehicle to be monitored and a driving track of the object vehicle. The static monitoring command can include an object to be monitored and monitoring content of the object. For example, the dynamic monitoring command can be a request to inquire current position of the object vehicle with the license plate number 123456, and the driving track of the object vehicle. The static monitoring command can be a request to inquire about contents of a billboard at en entrance of a department store, and check a status of a ticket office at an entrance of a park and so on.

In at least one embodiment, the receiving module 102 can inquire an authority of the terminal device 3. For example, the receiving module 102 can determine whether the terminal device 3 corresponding to the monitoring command has a query authority. When the terminal device 3 does not have the query authority, the receiving module 102 can send a query failure notification to the terminal device 3.

The searching module 103 can obtain a search result by searching in the database according to the monitoring command and/or the static monitoring command.

In at least one embodiment, the searching module 103 can search for a license plate number of an object vehicle corresponding to the dynamic monitoring command, the searching module 103 can search for at least one video according to the license plate number, the searching module 103 can acquire positions of the object vehicle of the at least one video and record time information when the object vehicle appeared at the acquired positions. The searching module 103 can acquire a driving track of the object vehicle by connecting the positions on a map according to the recorded time information, and search for an object imaging device which records a new video shows the object vehicle based on the table. The searching module 103 further can acquire a current video from the object imaging device, and determine whether the current video shows the object vehicle. The searching module 103 can output all the videos shows the object vehicle which were recorded by the searched imaging device and the driving track when the current video has the object vehicle. The searching module 103 can search for the object vehicle from the videos of the database when the current video does not show the object vehicle.

In at least one embodiment, the searching module 103 can track the object vehicle by connecting the positions on a map according to the recorded time information. For example, the searching module 103 can acquire position A of the object vehicle of the at least one video and recorded time information (e.g., 8:00) when the object vehicle appeared at the position A, the searching module 103 can acquire position B of the object vehicle of the at least one video and recorded time information (e.g., 9:00) when the object vehicle appeared at the position B, and the searching module 103 can acquire position C of the object vehicle of the at least one video and recorded time information (e.g., 10:00) when the object vehicle appeared at the position C. Then, the searching module 103 can acquire a driving track of the object vehicle by connecting the positions A, B, and C, and the driving track may be from A to B, and from B to C.

The searching module 103 can search for the imaging device 2 which records a newly video shows the object vehicle based on the relational table. For example, a first imaging device has record a video A shows the object vehicle at 8:00, and a video B shows the object vehicle at 10:00. A second imaging device has record a video C shows the object vehicle at 11:00, and a video D shows the object vehicle at 14:00. The searching module 103 can receive the video A, the video B, the video C, the video D, and the relational table. The relational table can include a first identification number of the first imaging device, and a second identification number of the second imaging device. The first identification number is corresponding to the video A and the video B. The second identification number is corresponding to the video C and the video D. The searching module 103 further can search for the second imaging device as the video D is the newly video shows the object vehicle.

In at least one embodiment, the searching module 103 can acquire position of an object to be monitored according to the static monitoring command, the searching module 103 can search for license plate numbers of vehicles within a preset range of the acquired position. For example, the preset range of the acquired position can be a circle, a center of the circle is the acquired position, and a radius of the circle is 10 meters. The searching module 103 further can acquire videos recorded by imaging device of the vehicles according to the license plate numbers. The searching module 103 can recognize the object to be monitored from the acquired videos by image recognition technology. The searching module 103 can determine whether the object is normal by comparing a state of the recognized object with a first state of the object stored in the database. For example, when the state of the recognized object is the same as the first state of the object, the searching module 103 can determined that the object is normal. When the state of the recognized object is different from the first state of the object, the searching module 103 can determined that the object is abnormal.

For example, the searching module 103 can receive a monitoring command sent by the terminal device 3 for searching a driving track of an object vehicle whose license plate number is 123456. The searching module 103 can search for the license plate number from the database, and search for videos and positions of the object vehicle according to the license plate number. The searching module 103 can acquire a driving track by marking the searched positions on the map according to a time sequence of the videos. The searching module 103 can search for an object imaging device which records a newly video shows the object vehicle based on the relational table, and the searching module 103 further can acquire a current video from the object imaging device, and determine whether the current video shows the object vehicle. The searching module 103 can output the video when the current video shows the object vehicle, and can search for the object vehicle in the database when the current video does not show the object vehicle.

In other embodiment, the searching module 103 can receive a monitoring command sent by the terminal device 3 to monitor a display of products in the window of a shopping mall. The searching module 103 can search for the license plate numbers located within 10 meters of the shopping mall according to the location of the shopping mall, and acquires videos having the license plate numbers. The searching module 103 can obtain images having a merchandise placement of the products in the window. The images are recognized by a deep learning algorithm based on a convolutional neural network. The searching module 103 can determine whether a state of the products is normal by comparing the merchandise placement of the products with a preset placement of the products in the database. When the merchandise placement of the products is the same with the preset placement of the products, the searching module 103 can determine that the state of the products is normal. When the merchandise placement of the products is different from the preset placement of the products, the searching module 103 can determine that the state of the products is abnormal.

The outputting module 104 can output the search result.

In at least one embodiment, the search result can be sent to the terminal device by any one of mail, short message, telephone, and instant messaging software.

For example, the outputting module 104 can send the search result to the terminal device 3 by mail, short message, telephone, or instant messaging software. The search result can include videos and/or feature information of the videos.

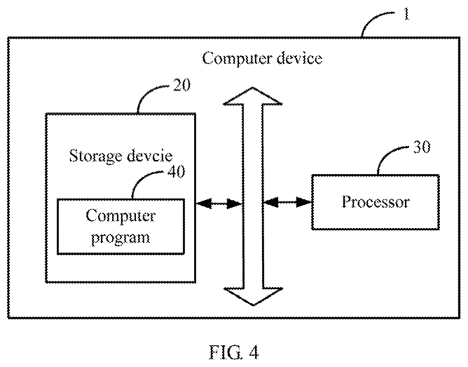

FIG. 4 shows one embodiment of a schematic structural diagram of a computer device. In an embodiment, a computer device 1 includes a storage device 20, at least one processor 30, and a computer program 40, such as a monitoring program, stored in the storage device 20 and executable on the processor 30. When the processor 30 executes the computer program 40, the steps in the foregoing monitoring method embodiment are implemented, for example, steps S1 to S4 shown in FIG. 2. Alternatively, when the processor 30 executes the computer program 40, the functions of the modules in the above-described monitoring device embodiment are implemented, such as the modules 101-104 in FIG. 3.

In at least one embodiment, the computer program 40 can be partitioned into one or more modules/units that are stored in the storage device 20 and executed by the processor 30 to complete the present invention. The one or more modules/units may be a series of computer program instruction segments capable of performing a particular function for describing the execution of the computer program 40 in the computer device 1. For example, the computer program 40 can be divided into the acquiring module 101, the receiving module 102, the searching module 103, and the outputting module 104 in FIG. 3. For details of the functions of the respective modules as shown in FIG. 3.

In at least one embodiment, the computer device 1 may be a computing device such as a desktop computer, a notebook, a palmtop computer, and a cloud server. It should be noted that the computer device 3 is merely an example, and other existing or future electronic products may be included in the scope of the present disclosure, and are included in the reference. Components, such as the computer device 1 may also include input and output devices, network access devices, buses, and the like.

In some embodiments, the at least one processor 30 may be composed of an integrated circuit, for example, may be composed of a single packaged integrated circuit, or may be composed of multiple integrated circuits of same function or different functions. The at least one processor 30 can include one or more central processing units (CPU), a microprocessor, a digital processing chip, a graphics processor, and various control chips. The at least one processor 30 is a control unit of the computer device 1, which connects various components of the computer device 1 using various interfaces and lines. By running or executing a computer program or modules stored in the storage device 20, and by invoking the data stored in the storage device 20, the at least one processor 30 can perform various functions of the computer device 1 and process data of the computer device 1. For example, the function of monitoring.

In some embodiments, the storage device 20 can be used to store program codes of computer readable programs and various data, such as the monitoring device 10 installed in the computer device 1, and automatically access to the programs or data with high speed during running of the computer device 1. The storage device 20 can include a read-only memory (ROM), a random access memory (RAM), a programmable read-only memory (PROM), an erasable programmable read only memory (EPROM), an one-time programmable read-only memory (OTPROM), an electronically-erasable programmable read-only memory (EEPROM)), a compact disc read-only memory (CD-ROM), or other optical disk storage, magnetic disk storage, magnetic tape storage, or any other storage medium readable by the computer device 1 that can be used to carry or store data.

The modules/units integrated by the computer device 1 can be stored in a computer readable storage medium if implemented in the form of a software functional unit and sold or used as a stand-alone product. Based on such understanding, the present invention implements all or part of the processes in the foregoing embodiments, and may also be implemented by a computer program to instruct related hardware. The computer program may be stored in a computer readable storage medium. The steps of the various method embodiments described above may be implemented by a computer program when executed by a processor. Wherein, the computer program comprises computer program code, which may be in the form of source code, object code form, executable file or some intermediate form. The computer readable medium may include any entity or device capable of carrying the computer program code, a recording medium, a USB flash drive, a removable hard disk, a magnetic disk, an optical disk, a computer memory, a read-only memory (ROM), random access memory (RAM, Random Access Memory), electrical carrier signals, telecommunications signals, and software distribution media. It should be noted that the content contained in the computer readable medium may be appropriately increased or decreased according to the requirements of legislation and patent practice in a jurisdiction, for example, in some jurisdictions, according to legislation and patent practice, computer readable media does not include electrical carrier signals and telecommunication signals.

The above description is only embodiments of the present disclosure, and is not intended to limit the present disclosure, and various modifications and changes can be made to the present disclosure. Any modifications, equivalent substitutions, improvements, etc. made within the spirit and scope of the present disclosure is intended to be included within the scope of the present disclosure.

What is claimed is:

1. A monitoring method applicable in a computer device, the method comprising:
acquiring videos recorded by an imaging device of a vehicle and a simultaneous position of the vehicle, and storing the videos and the position into a database;
receiving a monitoring command from a terminal device, wherein the monitoring command comprising a dynamic monitoring command and/or a static monitoring command;
obtaining a search result by searching in the database according to the monitoring command and/or the static monitoring command; and
outputting the search result.

2. The method according to claim 1, wherein acquiring videos recorded by an imaging device of a vehicle and position of the vehicle comprising:
receiving the videos send by the imaging device of the vehicle;
receiving the position of the vehicle send by a navigation device of the vehicle;
extracting feature information from the videos, wherein the feature information comprising license plate number of at least one vehicle of the videos; and
storing the videos, the extracted feature information, and the position of the vehicle into the database.

3. The method according to claim 2, wherein extracting feature information from the videos comprising:
searching for at least one key frame containing the feature information from the videos; and
extracting the feature information from the at least one key frame.

4. The method according to claim 2, wherein the dynamic monitoring command comprising a license plate number of an object vehicle to be monitored and a driving track of the object vehicle, the static monitoring command comprising an object to be monitored and monitoring content of the object.

5. The method according to claim 4, wherein the method further comprising:
searching for a license plate number of an object vehicle according to the dynamic monitoring command;
searching for at least one video of the object vehicle having the license plate number;
acquiring positions of the object vehicle of the at least one video;
recording time information when the object vehicle appeared at the acquired positions;
acquiring a driving track of the object vehicle by connecting the positions on a map according to the recorded time information;
searching for an object imaging device which records a newly video shows the object vehicle based on a relational table, wherein the relational table comprising at least one video recorded by the imaging device and an identification number of the imaging device;
acquiring a current video from the object imaging device;
determining whether the current video shows the object vehicle; and
outputting all the videos shows the object vehicle which record by the searched imaging device and the driving track when the current video shows the object vehicle.

6. The method according to claim 4, wherein the method further comprising:
acquiring position of an object to be monitored according to the static monitoring command;
searching for license plate numbers of vehicles within a preset range of the acquired position;
acquiring videos recorded by imaging device of the vehicles according to the license plate numbers;
recognizing the object to be monitored from the acquired videos;
determining whether the object is normal by comparing a state of the recognized object with a first state of the object stored in the database;
determining that the object is normal when the state of the recognized object is the same as the first state of the object; and
determining that the object is abnormal when the state of the recognized object is different from the first state of the object.

7. The method according to claim 1, wherein the method further comprising:
determining whether the terminal device corresponding to the monitoring command has a query authority; and
sending a query failure notification to the terminal device when the terminal device does not have the query authority.

8. A computer device comprising:
a storage device;
at least one processor; and
the storage device storing one or more programs that, when executed by the at least one processor, cause the at least one processor to:
acquire videos recorded by an imaging device of a vehicle and a simultaneous position of the vehicle, and storing the videos and the position into a database;
receive a monitoring command from a terminal device, wherein the monitoring command comprising a dynamic monitoring command and/or a static monitoring command;
obtain a search result by searching in the database according to the monitoring command and/or the static monitoring command; and
output the search result.

9. The computer device according to claim 8, wherein acquire videos recorded by an imaging device of a vehicle and position of the vehicle comprising:
receive the videos send by the imaging device of the vehicle;
receive the position of the vehicle send by a navigation device of the vehicle;
extract feature information from the videos, wherein the feature information comprising license plate number of at least one vehicle of the videos; and
store the videos, the extracted feature information, and the position of the vehicle into the database.

10. The computer device according to claim 9, wherein extract feature information from the videos comprising:
search for at least one key frame containing the feature information from the videos; and
extract the feature information from the at least one key frame.

11. The computer device according to claim 9, wherein the dynamic monitoring command comprising a license plate number of an object vehicle to be monitored and a driving track of the object vehicle, the static monitoring command comprising an object to be monitored and monitoring content of the object.

12. The computer device according to claim 11, wherein the at least one processor is further caused to:
search for a license plate number of an object vehicle according to the dynamic monitoring command;
search for at least one video of the object vehicle having the license plate number;
acquire positions of the object vehicle of the at least one video;
record time information when the object vehicle appeared at the acquired positions;
acquire a driving track of the object vehicle by connecting the positions on a map according to the recorded time information;
search for an object imaging device which records a newly video shows the object vehicle based on a relational table, wherein the relational table comprising at least one video recorded by the imaging device and an identification number of the imaging device;
acquire a current video from the object imaging device;
determine whether the current video shows the object vehicle; and
output all the videos shows the object vehicle which record by the searched imaging device and the driving track when the current video shows the object vehicle.

13. The computer device according to claim 11, wherein the at least one processor is further caused to:
acquire position of an object to be monitored according to the static monitoring command;
search for license plate numbers of vehicles within a preset range of the acquired position;
acquire videos recorded by imaging device of the vehicles according to the license plate numbers;
recognize the object to be monitored from the acquired videos;
determine whether the object is normal by comparing a state of the recognized object with a first state of the object stored in the database;
determine that the object is normal when the state of the recognized object is the same as the first state of the object; and
determine that the object is abnormal when the state of the recognized object is different from the first state of the object.

14. The computer device according to claim 8, wherein the at least one processor is further caused to:
determine whether the terminal device corresponding to the monitoring command has a query authority; and
send a query failure notification to the terminal device when the terminal device does not have the query authority.

15. A non-transitory storage medium having stored thereon instructions that, when executed by a processor of a computer device, causes the processor to perform a monitoring method, the computer device comprising a battery, the method comprising:
acquiring videos recorded by an imaging device of a vehicle and a simultaneous position of the vehicle, and storing the videos and the position into a database;
receiving a monitoring command from a terminal device, wherein the monitoring command comprising a dynamic monitoring command and/or a static monitoring command;
obtaining a search result by searching in the database according to the monitoring command and/or the static monitoring command; and
outputting the search result.

16. The non-transitory storage medium according to claim 15, wherein acquiring videos recorded by an imaging device of a vehicle and position of the vehicle comprising:
receiving the videos send by the imaging device of the vehicle;
receiving the position of the vehicle send by a navigation device of the vehicle;
extracting feature information from the videos, wherein the feature information comprising license plate number of at least one vehicle of the videos; and
storing the videos, the extracted feature information, and the position of the vehicle into the database.

17. The non-transitory storage medium according to claim 16, wherein extracting feature information from the videos comprising:
searching for at least one key frame containing the feature information from the videos; and
extracting the feature information from the at least one key frame.

18. The non-transitory storage medium according to claim 16, wherein the dynamic monitoring command comprising a license plate number of an object vehicle to be monitored and a driving track of the object vehicle, the static monitoring command comprising an object to be monitored and monitoring content of the object.

19. The non-transitory storage medium according to claim 18, wherein the method further comprising:
searching for a license plate number of an object vehicle according to the dynamic monitoring command;
searching for at least one video of the object vehicle having the license plate number;
acquiring positions of the object vehicle of the at least one video;
recording time information when the object vehicle appeared at the acquired positions;
acquiring a driving track of the object vehicle by connecting the positions on a map according to the recorded time information;
searching for an object imaging device which records a newly video shows the object vehicle based on a relational table, wherein the relational table comprising at least one video recorded by the imaging device and an identification number of the imaging device;
acquiring a current video from the object imaging device;
determining whether the current video shows the object vehicle; and
outputting all the videos shows the object vehicle which record by the searched imaging device and the driving track when the current video shows the object vehicle.

20. The non-transitory storage medium according to claim 18, wherein the method further comprising:
acquiring position of an object to be monitored according to the static monitoring command;
searching for license plate numbers of vehicles within a preset range of the acquired position;
acquiring videos recorded by imaging device of the vehicles according to the license plate numbers;
recognizing the object to be monitored from the acquired videos;
determining whether the object is normal by comparing a state of the recognized object with a first state of the object stored in the database;
determining that the object is normal when the state of the recognized object is the same as the first state of the object; and
determining that the object is abnormal when the state of the recognized object is different from the first state of the object.
